(19) United States
(12) Patent Application Publication
(10) Pub. No.: US 2024/0244573 A1
(43) Pub. Date: Jul. 18, 2024

(54) FIRST LOCATION SERVER AND A METHOD THEREIN

(71) Applicant: Telefonaktiebolaget LM Ericsson (publ), Stockholm (SE)

(72) Inventors: Ananya MUDDUKRISHNA, Enskededalen (SE); Dhruvin PATEL, Aachen (DE); Yufei BLANKENSHIP, Kildeer, IL (US); Fedor CHERNOGOROV, Espoo Uusimaa (FI)

(21) Appl. No.: 18/291,673

(22) PCT Filed: Jul. 27, 2021
(86) PCT No.: PCT/SE2021/050757

§ 371 Date: Jan. 24, 2024

(51) Int. Cl. H04W 64/00; H04W 84/04

(52) U.S. Cl. CPC H04W 64/003; H04W 84/047

(57) ABSTRACT

A method performed by a first location server for handling location data in a wireless communications network is provided. The first location server determines a first location of a first relay node. The first location of the first relay node is based on a signaling performed between the first relay node and a first set of network nodes. The first location server triggers a determination of a second location of a second network device. The second network device is any of: a first User Equipment (UE) wirelessly connected with the first relay node, or a second relay node. The second location is triggered to be determined based on the first location.

### TECHNICAL FIELD

Embodiments herein relate to a first location server and a method therein. Furthermore, a computer program and a computer readable storage medium are also provided herein. In particular, embodiments herein relate to handling location data in a wireless communications network.

### BACKGROUND

In a typical wireless communications network, wireless devices, also known as wireless communication devices, mobile stations, mobile terminals, mobile equipment, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as areas covered by a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with a wireless device within range of the radio network node.

3GPP is the standardization body for specifying the standards for the cellular system evolution, e.g., including 3G, 4G, 5G and the future evolutions, e.g. 6G. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands used for 5G NR are being mainly in two different frequency ranges, Frequency Range 1 (FR1) and Frequency Range 2 (FR2), with more frequency ranges being investigated for higher carrier frequency bands, e.g., such as interval ranges 52.6-71 GHz and 71-114.25 GHz. FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may bring benefit to system performance when each UE only has one antenna. Such systems and/or related techniques are commonly referred to as MIMO.

Relay nodes are useful for providing range extension in wireless communications networks. A relay node may be used for relaying wireless communication between a network node a UE, or one network node and another network node. The direction of data transmission can be upstream, e.g., from the UE to the network node, or downstream, e.g., from the network node to the UE. Relaying when used herein may mean to forward radio communication such as e.g. one or more messages and/or data packers, from one source node to a destination node. For different configurations and use cases, a relay node as used herein may be any suitable device for relaying radio communication such as e.g., a repeater, an Integrated Access and Backhaul (IAB) node, an intelligent surface, etc. In some use cases, the link over which radio communication is relayed may be referred to as a wireless backhaul link. Relaying radio communication may be needed when the destination node, e.g., a UE, is outside of a radio coverage provided by the source node e.g., a network node such as e.g. a base station. There may be one or more relay nodes between the source node and the destination node, with multiple relay nodes forming a multi-hop network. In other words, single-hop and multi-hop are both possible architecture options when deploying relay nodes. Single-hop may also be referred to as single-hop backhauling or single-hop relaying. Multi-hop may also be referred to as multi-hop backhauling or multi-hop relaying. Single-hop refers to that only one relay node is used for relaying communication. This may be exemplified by a network node sending a message to a relay node, where the relay node subsequently relays the message to the UE. Multi-hop refers to that more than one relay node is used for relaying communication between the source node and the destination node. This may be exemplified by a two-hop example, where the network node sends a message to a first relay node, wherein the first relay node subsequently relays, the message to a second relay node, and wherein the second relay node relays, the message to the UE. In multi-hop relaying, any suitable number of hops between the source node and the destination node is possible. Compared to single-hop backhauling, multi-hop backhauling provides an increased range extension which is especially beneficial for above-6 GHz frequencies due to their limited range. Multi-hop backhauling further enables backhauling around obstacles, e.g. buildings in urban environment for in-clutter deployments. One example of relay node is an IAB node defined in NR, which is composed of a Mobile-Termination (MT) and a Digital Unit (DU).

There are numerous types of relay node, each with different configurations and capabilities. A relay node can be fixed or mobile. Furthermore, a relay node may be deployed as a half-duplex or full-duplex. Half-duplex as used herein is sometimes referred to as in-band backhaul and means that the relay node cannot transmit and receive simultaneously on an access link and a backhaul link. An access link as used herein is a link between the relay node and its downstream node. A backhaul link as used herein is a link between the relay node and its upstream node. Full-duplex as used herein is sometimes referred to as out-of-band backhaul and means that the relay node can communicate simultaneously on the access link and backhaul link.

A relay node may be regenerative or non-regenerative. For regenerative relay nodes, every packet traversing a backhaul link is properly decoded and re-encoded for transmission on the access link, i.e., the signal is cleaned up before forwarding whereas incoming noise and distortion are removed by the relay node. A non-regenerative relay node simply amplify-and-forward everything that it receives, i.e., any incoming noise and distortion is passed on together with the received signal.

### SUMMARY

As a part of developing embodiments herein a problem was first identified and will be discussed herein. A drawback of multi-hop relaying is that there may be a large quantity of relay nodes deployed at various flexible locations. In other words, their locations, also referred to as positions, may not be carefully selected and are not known without manual calibration of the relay nodes. A solution for this may be to have a Global Positioning System (GPS) receiver for every relay node for determining their respective location. However, a GPS receiver for every relay node is not very cost-efficient, and furthermore, when a relay node is located indoors, e.g., inside a factory, the location may not be able to be determined via GPS. When the relay nodes' locations are not known, it is difficult to locate the UEs served by the relay nodes. There are many use cases where a UE is wirelessly connected with a relay node where the UE needs to be located with high precision and/or accuracy. For example the UE may be a mobile robot in a smart factory performing high precision operation and thus need to be located with high precision in order to perform the desired function within the factory. In another example the UE is an Augmented Reality (AR) device or a Virtual Reality (VR) device. In these examples, in order to properly support audio-visual rendering, the UEs position horizontally and/or vertically need to be determined with high precision and/or accuracy. Hence, it is desirable to locate the locations of the relay nodes in a cost-efficient and automated manner without manual intervention. After the relay nodes' locations are determined, the UEs wirelessly connected to them may further be located with good accuracy even if the UEs are located behind obstacles.

An object of embodiments herein is to improve localization services in wireless communications networks.

According to an aspect of embodiments herein, the object is achieved by a method performed by a first location server for handling location data in a wireless communications network. The first location server determines a first location of a first relay node. The first location of the first relay node is based on a signaling performed between the first relay node and a first set of network nodes. The first location server triggers a determination of a second location of a second network device. The second network device is any of: a first UE wirelessly connected with the first relay node, or a second relay node. The second location is triggered to be determined based on the first location.

According to another aspect of embodiments herein, the object is achieved by a first location server configured to handle location data in a wireless communications network. The first location server is configured to determine a first location of a first relay node. The first location of the first relay node is based on a signaling performed between the first relay node and a first set of network nodes. The first location server is further configured to trigger a determination of a second location of a second network device. The second network device is any of: a first UE wirelessly connected with the first relay node, or a second relay node. The second location is triggered to be determined based on the first location.

It is furthermore provided herein a computer program comprising instructions, which, when executed on at least one processor, cause the at least one processor to carry out any of the methods above, as performed by the first location server. It is additionally provided herein a computer-readable storage medium, having stored thereon a computer program comprising instructions which, when executed on at least one processor, cause the at least one processor to carry out the method according to any of the methods above, as performed by the first location server.

Since the first location server determines the first location of the first relay node, the first location server is enabled to trigger a determination of the second location of the second network device based on the first location. In this way, a better accuracy of determining the second location of the second network device is achieved.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in first location server.

FIG. 3 is a schematic block diagram illustrating embodiments herein.

FIG. 4 is a combined sequence diagram and flowchart illustrating embodiments herein.

FIG. 5a-b are schematic block diagrams illustrating embodiments of a first location server.

FIG. 6 schematically illustrates a telecommunications network connected via an intermediate network to a host computer.

FIG. 7 is a generalized block diagram of a host computer communicating via a base station with a user equipment over a partially wireless connection.

FIGS. 8-11 are flowcharts illustrating methods implemented in a communication system including a host computer, a base station and a user equipment.

### DETAILED DESCRIPTION

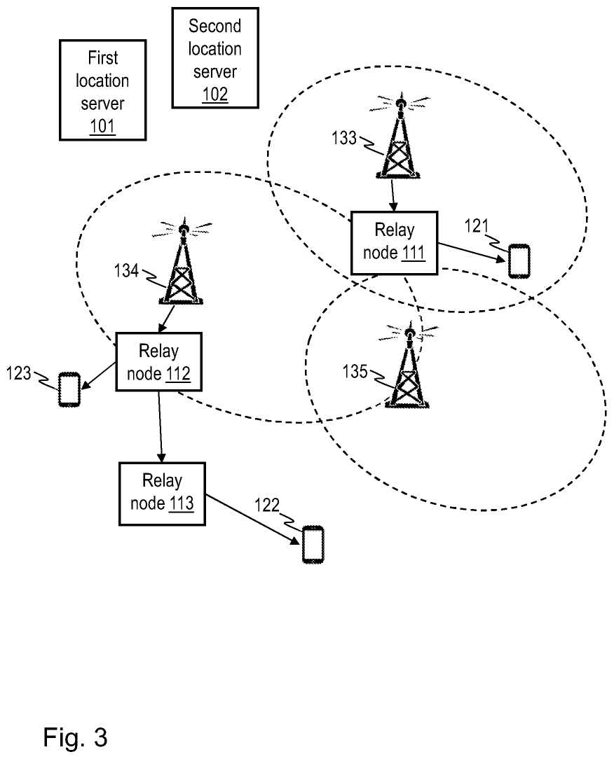

FIG. 3 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

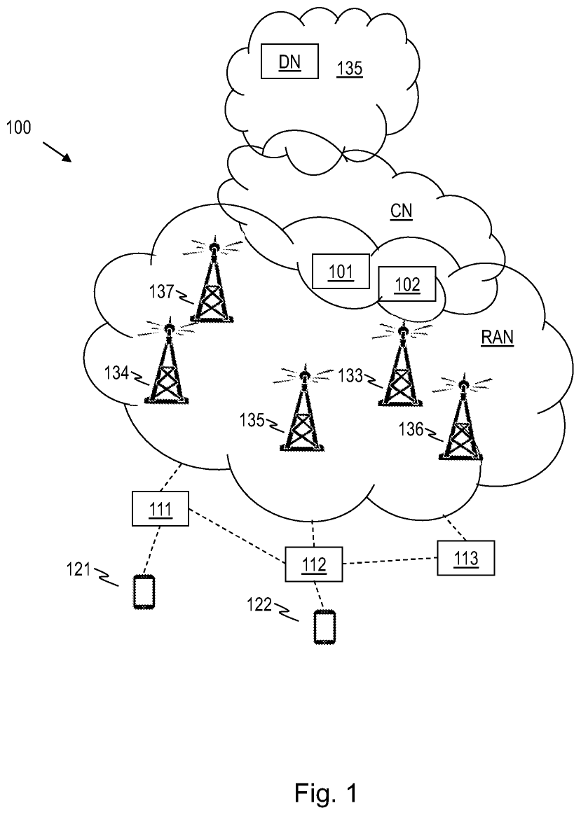

A number of network nodes operate in the wireless communications network 100 such as e.g. a first set of network nodes 133, 134, 135, 136, 137, and a second set of network nodes 133, 134, 135, 136, 137. The first and second set of network nodes may each respectively comprise one or more network nodes, e.g. a third network node 133, a fourth network node 134, a fifth network node 135, a sixth network node 136, and/or a seventh network node 137. The network nodes comprised in the first and second set of network nodes may be the same network nodes, partially the same network nodes, or different network nodes. In other words, the network nodes 133, 134, 135, 136, 137 illustrated in FIG. 1 may each be comprised in any one or both of the first set of network nodes and the second set of network nodes. The network nodes comprised in the first and second set of network nodes may be IAB donor gNBs. Each network node comprised in the first and second set of network nodes 133, 134, 135, 136, 137 may respectively be a serving network node which provides radio coverage, e.g. in a cell, e.g. to any one or more out of a first UE 121, a second UE 122, a first relay node 111, a second relay node 112, and/or a third relay node 113. Each network node comprised in the first set of network nodes 133, 134, 135, 136, 137 and/or the second set of network nodes 133, 134, 135, 136, 137 may respectively be any of a NG-RAN node, a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating over radio, e.g. with any one or more out of the first UE 121, the second UE 122, the first relay node 111, the second relay node 112, and/or the third relay node 113.

A number of location servers operate in the wireless communications network 100 such as e.g. a first location server 101 and a second location server 102. The first location server 101 and the second location server 102 may each be capable of managing the location data of network devices, e.g. UEs and/or relay nodes such as the first UE 121, the second UE 122, the first relay node 111, the second relay node 112, and/or the third relay node 113. The first location server 101 and/or the second location server 102 may respectively be a Location Management Function (LMF), e.g. as defined in NR. The first location server 101 and/or the second location server 102 respectively may manage a support of different location services for one or more network devices, e.g. for any one or more out of the first UE 121, the second UE 122, the first relay node 111, the second relay node 112, and/or the third relay node 113. The location services may include positioning, e.g. determining a location, of these network devices and/or delivery of assistance data to one or more network devices. The first location server 101 and/or the second location server 102 may respectively interact with one or more network nodes, e.g. serving network nodes, such as any one or more out of the network nodes in the first or second set of network nodes above. This interaction may be necessary for the first location server 101 and/or the second location server 102 to obtain position measurements for a network device to be located. This may be performed e.g. by receiving uplink measurements made by a network node in the first or second set of network nodes related to the network device to be located, and/or downlink measurements made by the network device to be located which were provided to the network node in the first or second set of network nodes. The first location server 101 and/or the second location server 102 may respectively interact with a network device to be located in order to deliver assistance data and/or to obtain a determined location estimate. The network device to be located may be able to determine its location based on receiving the assistance data. The first location server 101 and/or the second location server 102 may further interact with multiple network nodes, e.g. in the first and/or second set of network nodes, to provide assistance data to a network device to be located. The first location server 101 and/or the second location server 102 may respectively combine information from multiple results and methods to determine a location a network device to be located, also referred to as hybrid positioning. Additional information such as e.g. accuracy of the location estimation and/or velocity of the network device to be located may also be determined. Furthermore, the first location server 101 and the second location server 102 may be logical entities. Physically they may be co-located, or they may be separate location servers. Similarly, any of the first location server 101 and the second location server 102 may be co-located with any of the network nodes in the first set of network nodes 133, 134, 135, 136, 137 and/or the second set of network nodes 133, 134, 135, 136, 137.

In the wireless communications network 100, one or more relay nodes operates, such as e.g. the first relay node 111, the second relay node 112, and/or the third relay node 113. Each of the first relay node 111, the second relay node 112, and/or the third relay node 113 may respectively be a regenerative type of relay node, e.g. an IAB node, or a non-regenerative type of relay node, e.g. a repeater node. Any of the first relay node 111, the second relay node 112, and/or the third relay node 113 may respectively be any of a mobile or stationary relay node. Any of the first relay node 111, the second relay node 112, and/or the third relay node 113 may be a single-hop relay node, and may relay radio communication, e.g. messages and/or data packets between a UE, e.g. the first UE 121 or the second UE 122, and network node, e.g. any one of the network nodes in the first set of network nodes 133, 134, 135, 136, 137, and the second set of network nodes 133, 134, 135, 136, 137. For example, the first relay node 111 may relay messages and/or data packets between the first UE 121 and the third network node 133. The second relay node 112 may relay messages and/or data packets between the second UE 122 and the fourth network node 134. Any of the first relay node 111, the second relay node 112, and/or the third relay node 113 may also be configured to operate as multi-hop relay nodes. As an example, the first relay node 111 and the second relay node 112 may relay messages and/or data packets between the second UE 122 and the fifth network node 135. In this scenario, the fifth network node 135, sends a message to the second UE 122 by sending the message to the first relay node 111, wherein the first relay node 111 relays the message to the second relay node 112, and wherein the second relay node 112 relays the message to the second UE 122.

In the wireless communications network 100, one or more UEs operate, such as e.g. the first UE 121 and the second UE 122. The first UE 121 and the second UE 122 may each respectively be referred to as a wireless device, an internet of things (IoT) device, a mobile station, a non-access point (non-AP) STA, a STA, and/or a wireless terminals. The first UE 121 and/or the second UE 122 may communicate via one or more Access Networks (AN), e.g. RAN, e.g. via the first, second or third relay nodes 111, 112, 113, to one or more Core Networks (CN). It should be understood by the skilled in the art that “wireless device” or UE, is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell. The first UE 121 and/or the second UE 122 may be wirelessly connected to the first, second and/or third relay nodes 111, 112, 113.

Methods herein may be performed by the first location server 101 also referred to as the location server. As an alternative, a Distributed Node (DN) and functionality, e.g. comprised in a cloud 135 as shown in FIG. 1, may be used for performing or partly performing the methods herein.

The first location server 101 may in embodiments herein be configured to determine a first location of the first relay node 111. When the first location is determined, the first location server 101 may further trigger a determination of a second location of a second network device e.g. the first UE 121 or the second relay node 112, based on the first location. The second location is thus determined with increased accuracy since it may be based on the first location of the first relay node 111. This may relate to increased accuracy since the first location is closer to the second location than alternative locations of available network nodes. Furthermore, the second location may not be determinable without the first location, e.g. if the second network device associated with the second location is out of coverage.

A number of embodiments will now be described, some of which may be seen as alternatives, while some may be used in combination.

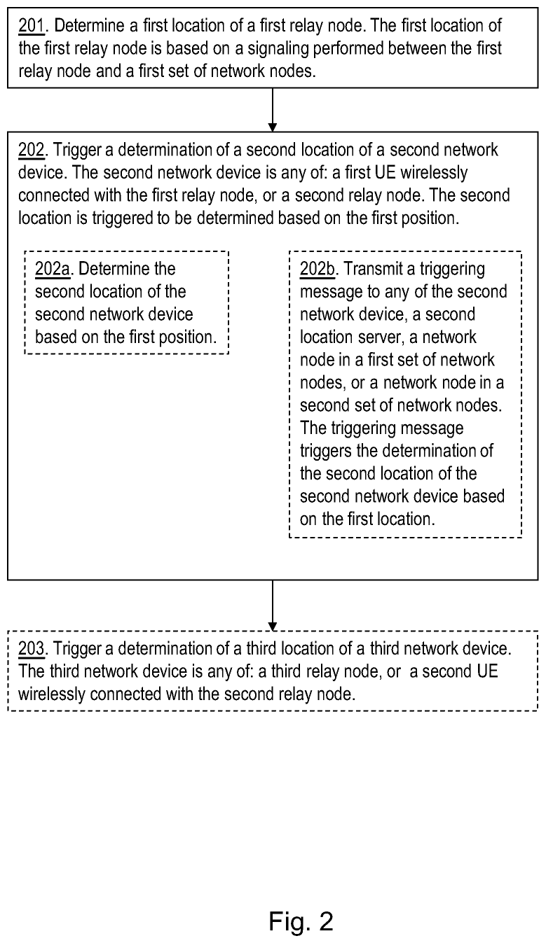

FIG. 2 shows example embodiments of a method performed by the first location server 101 for handling location data in the wireless communications network 100. The method comprises the following actions, which actions may be taken in any suitable order. Optional actions are referred to as dashed boxes in FIG. 2.

Action 201. The first location server 101 determines the first location of the first relay node 111. The first location of the first relay node 111 is based on a signaling performed between the first relay node 111 and the first set of network nodes 133, 134, 135, 136, 137. The first location server 101 determines the first location based on the signaling performed between the first relay node 111 and the first set of network nodes 133, 134, 135, 136, 137 by any suitable way of using the signaling between the first relay node 111 and the first set of network nodes 133, 134, 135, 136, 137. The first location server 101 may for example trigger the signaling, e.g. by sending an initialization message to the network nodes in the first set of network nodes 133, 134, 135, 136, 137 and/or to the first relay node 111. The first location server 101 may further be informed of the signaling e.g. by obtaining data relating to the signaling from the first relay node 111 and/or the network nodes in the first set of network nodes 133, 134, 135, 136, 137. Additionally or alternatively, the signaling is sent to the first location server 101, e.g. the signaling may be sent via the first location server 101. The signaling may in some embodiments be performed between the first relay node 111 and at least three other network nodes, so that triangulation may be applied to locate the first relay node 111. In other words, the first set of network nodes may comprise at least three network nodes such as e.g. the third network node 133, the fourth network node 134 and the fifth network node 135. However, while triangulation may be used, other positioning techniques are available where fewer network nodes may be needed as will be explained. The location of the first set of network nodes may be known by the first location server 101 in advance, or may be obtained when performing or triggering the signaling. The first location may thus be determined based on the location of the network nodes in the first set of network nodes.

In some embodiments, the first location server 101 determines the first location based on any one or more out of: one or more network node identifiers (IDs), one or more cell IDs (CIDs), at least one Angle of Arrival (AoA) value, at least one Angle of Departure (AoD), value, at least one Timing Advance (TA) value, at least one signal quality value, pattern matching, at least one time difference value, and a barometric pressure value. Any one or more of these parameters may be used independently or in addition to one or more other parameters to determine the first location, e.g. where an increased number of parameters may in some embodiments determine the first location with improved accuracy. These parameters may be used in any suitable manner according to any suitable positioning methods.

The one or more network node identifiers may be mapped to a location of the set of network node. The network node identifiers may be Physical Cell IDs (PCIs), Global Cell IDs (GCIs), Transmission Point (TP) IDs of TPs connected to the network node, Cell Portion ID, Base Station Identity Code (BSIC), Service Set Identifier (SSID) of the Wireless Location Area Network (WLAN) access point, Basic Service Set Identifier (BSSID) of the WLAN access point, Medium access control (MAC) address of a Bluetooth beacon, etc. In this way it may be possible to determine the first location based on the locations of the network nodes in the first set of network nodes. The one or more cell identifiers, e.g. cell ID, or enhanced cell ID, may additionally or alternatively to the network node identifier be mapped to an approximate location of the cell, e.g. the service area, and/or a location of the network node serving the cell. In some embodiments, the one or more network node IDs may be associated with a network node serving the first relay node 111 and/or the first UE 121. The one or more CIDs may be e.g. Enhanced Cell IDs (E-CIDs). The measurement for E-CID may include Reference Signal Received Power (RSRP), Reference Signal Received Quality (RSRQ), Received Signal Strength Indicator (RSSI), AoA, Timing Advance, Rx−Tx time difference measured at the network device, or Rx−Tx time difference. In some embodiments the first location is determined based on a DL AoD (DL-AoD) value which uses the measurement of spatial information of the downlink radio signal which is transmitted by first set of network nodes. In some embodiments the first location is determined based on an UL AoA (UL-AoA) value which is based on a measurement of spatial information of uplink radio signals received by the first set network nodes.

In some embodiments when at least one UL-AoA value is known to the location server 101 and/or the first set of network nodes. The first location may be determined by combining the measured UL-AoA information together with the measured UL signal quality, where the UL signal quality may provide a distance between the first set of network nodes and the first relay node 111. If multiple AoA values, e.g. UL AoA values, e.g. measured by multiple Transmission Points (TPs) at the first set network nodes, are known, then the location of the first relay node 111 may be computed by combining multiple angular information about the relay node 111. This may be similar to an UL AoA method where the measurement is performed by the first set of network nodes. In some embodiments, a DL AoD method may be used where the measurement is performed by the first relay node 111 based on DL signal(s), where the DL signal(s) may be transmitted from multiple TPs, and where the measurement may include DL RSRP in addition to angular information.

In some embodiments the first location may be determined based on an Observed Time Difference of Arrival (OTDOA) positioning, Downlink Time Difference Of Arrival (DL-TDOA) and/or Uplink Relative Time of Arrival (UL-TDOA). The DL-TDOA method is based on a measured timing of downlink signals received from the first set of network nodes.

The UL-TDOA method is based on a measured timing of uplink signals which are received the first set of network nodes.

In embodiments using OTDOA, e.g., for LTE, and/or DL-TDOA, e.g., for NR, the first location is determined based on a DL Reference Signal Time Difference (RSTD), and optionally DL RSRP, measurements taken at the first relay node 111 downlink radio signals from multiple transmission points, along with knowledge of the geographical coordinates of the transmission points and their relative downlink timing. The multiple transmission points may belong to the same network node or belong to different network nodes in the first set of network nodes. For example, the first relay node 111 may measure RSTD among three transmission points, where each transmission point belongs to a different gNB of NR. A typical example of DL reference signal is the Positioning Reference Signal (PRS).

In embodiments using OTDOA, e.g. for LTE, and/or UL-TDOA, e.g. for NR, the first location is determined by the first relay node 111 being configured to transmit a UL reference signal, e.g. a Sounding Reference Signal (SRS). At the network node side, the reception points (RPs) of the first set of network nodes may measure the relative time of arrival, and optionally UL SRS RSRP, of the received signals using assistance data received from the first location server 101. The resulting measurements may then be used along with other configuration information to determine the first location. Note that the transmit point and reception point are often realized by the same antenna set, and hence called Transmission-Reception Point (TRP).

In some embodiments, the Reference Signal Time Difference (RSTD) or Time Difference Of Arrival measurements may provide information about difference between two distances, i.e., by multiplying the speed-of-light with the time difference, with one being the distance between the first relay node 111 and a first TRP, and another being the distance between the first relay node 111 and a second TRP. By combining multiple sets of distance differences, the first location may be determined.

In some embodiments, the first location may be determined based on at least one TA. In these embodiments, the TA provides the propagation time estimation between the network node and the device. The distance is then estimated by multiplying the speed-of-light with the propagation time. The distance information may also be provided by the measurement of radio signal strength or quality, e.g., RSRP, RSRQ, RSSI, based on the mathematical model of received power as a function of distance and transmitted power.

In some embodiments the first location is determined based on at least one signal quality value. The signal quality value may e.g. be a Reference Signal Received Power (RSRP), Reference Signal Received Quality (RSRQ), or any other suitable metric indicating a quality and/or strength of a signal. The signal quality value may relate to the network nodes in the first set of network nodes, and it may thus be possible to determine the location of the network nodes in the first set of network nodes, and further, use this information to determine the first location. The distance information may be used together with a CID, e.g. E-CID, to provide location estimation of the device. Alternatively, the distance information may be used together with angular, i.e., spatial, information between a TRP of a network node in the first set of network nodes and the first relay node 111 to determine the first location.

In some embodiments the first location is determined based on Radio Frequency (RF) Pattern Matching, or RF fingerprinting. For example, RF patterns may be measured and stored for certain known locations. When a device shows up in one of the locations with stored RF pattern, then the real-time RF signal measurement may be compared with the stored pattern to locate the device.

A barometric pressure measurement herein may e.g. be used for estimating vertical position, i.e. height, and may e.g. be a measurement performed by the first relay node 111. For further accuracy, the vertical position may be based on a local barometric pressure reference info received from any suitable source such as e.g. the first location server 101 and/or any network node in the first set of network nodes 133, 134, 135, 136, 137. For example, the first relay node 111 may be equipped with a barometric sensor which measures the atmospheric pressure at the first relay node 111. A height determination algorithm may be applied to estimate the height of the first relay node 111 by using a reference atmospheric pressure.

Any above measurements or methods may be used together in a hybrid manner which helps to improve positioning accuracy. This also makes the positioning protocol more robust, for example, when radio signal needed for one method is not available or too weak, it is possible to fall back to another method which has adequate measurement information.

Action 202. The first location server 101 triggers the determination of the second location of the second network device. In these embodiments, the second network device is any of: the first UE 121 wirelessly connected with the first relay node 111, or the second relay node 112. The second location is triggered to be determined based on the first location. The second location may be determined by any suitable method, e.g., any positioning method used for determining the first location with reference to action 201. In some embodiments, the entity that determines the second location may be any suitable entity such as e.g. the first location server 101, the second location server 102, or the second network device 121, 112. From the perspective of determining the second location, e.g. location calculation, the mode of positioning a network device such as the second network device 121, 112 may be categorized as either device-based or location-server-based, where the suffix-based refer respectively to the entity which is responsible for determining the location, e.g. making the positioning calculation. From the perspective of making measurements for positioning, the mode of positioning a device, e.g., the second network device 121, 112 may be categorized as either device-assisted or network-assisted, where the suffix-assisted refers to the entity which provides measurements, but which does not make the positioning calculation. For example, for a network-assisted barometric pressure sensor method, the first location server 101 may send a reference pressure value to the second network device 121, 112 as assistance data. As another example, when measurements are provided by the second network device 121, 112, to the first location server 101 to be used in the computation of the second location may be described as device-assisted and/or location server-based. In yet another example, when the operation where the second network device 121, 112 determined its own position may be described as device-based. In these embodiments, the first and/or second location server 101, 102 may provide assistance data to the second network device 121, 112. In the device-assisted mode, after determining its location, the second network device 121, 112, may further share, e.g. transmit, its location information to the first location server 101.

In some embodiments, the first location server 101 triggers the determination of the second location of the second network device 121, 112 to be determined based on the first location and any one or more out of: a signaling between the second network device 121, 112 and the second set of network nodes 133, 134, 135, 136, 137, and a signaling between the second network device 121, 112 and the first relay node 111. For example, the angular information and the distance information between the first relay node 111 and second network device 121, 112 may be used to position the second network device 121, 112 with reference to the position of the first relay node 111. In this way, the second location is determined at least partially based on the first location, thus improving the accuracy of determining the second location as the location of the first relay node may be used. It may e.g. in this way be more efficient to locate the second network device 121, 112, e.g. if the second network device 121, 112 is otherwise blocked behind an obstacle.

In some embodiments comprising multiple measurements between multiple radio nodes, e.g. the first relay node 111, and/or the second set of network nodes 133, 134, 135, 136, 137, and the second network device 121, 112, the measurements may be aggregated to improve the location estimation of the second network device 121, 112. As an example, the first location server 101 may transmit the first location to the first relay node 111 and to the network nodes in the second set of network nodes such as e.g. the sixth network node 136 and the seventh network node 137. The second location may be determined in a similar way as determining the first location, e.g. based on any one or more out of: one or more network node IDs, one or more cell IDs, at least one AoA value, at least one Angle of Departure, AoD, value, at least one TA value, at least one signal quality value, pattern matching, at least one time difference value, and a barometric pressure value. The second network device 121, 112 may e.g. derive its own location, e.g. the second location, based on radio signals and location of the first relay node 111, e.g. the first location, and the location of the network nodes in the second set of network nodes.

Action 202a. In some embodiments, the first location server 101 triggers the determination of the second location by determining the second location of the second network device 121, 112 based on the first location. In other words, the first location server 101 may determine the second location by using any suitable method described above.

Action 202b. In some embodiments, the first location server 101 triggers the determination of the second location by transmitting a triggering message to any of the second network device 121, 112, the second location server 102, a network node in a first set of network nodes, and/or a network node in a second set of network nodes. The triggering message may trigger the determination of the second location of the second network device 121, 112 based on the first location. The triggering message may in some embodiments be an instruction to trigger the determination of the second location. In other words, the first location server 101 may, using the triggering message, instruct the second location server 102, and/or the second network device 121, 112 to determine the second location based on the first location by using any suitable positioning method. In another embodiment, the first location server 101 may signal the second location server 102, and/or a network/node in the first and/or second set of network nodes, to transmit information to assist with the estimation of the second location, e.g., the second location server 102 is signaled to send a PRS, or the second location server 102 is signaled to perform measurements based on the UL Reference Signals (RS) of the second network device 121, 112. In some embodiments the second location server 102 is signaled to configure the second network device 121, 112 to transmit UL RS. In another embodiment, the first location server 101 may signal the second network device 121 to determine its own location. In some of these embodiments, the first UE 121 may be served by any relay node, e.g. the first relay node, or any network node in the first and/or second set of network nodes.

Action 203. In some embodiments, the second network device 121, 112, may be the second relay node 112. In these embodiments, the first location server 101 triggers a determination of a third location of a third network device 122, 113. In these embodiments, third network device 122, 113 is any of: the third relay node 113, or the second UE 122 wirelessly connected with the second relay node 112. The third location may be determined in a similar way as determining the first location, e.g. based on any one or more out of: one or more network node IDs, one or more cell IDs, at least one AoA value, at least one AoD value, at least one TA value, at least one signal quality value, pattern matching, at least one time difference value, and a barometric pressure value. In this way, the locations of two different relay nodes may be used to more efficiently determine the third location.

In some of the above embodiments of actions 201-203, the first relay node 111 and/or the second relay node 112 is a regenerative type of relay node. In regenerative types of relay nodes, every data packet received by the relay node is decoded and then re-encoded for transmission on the subsequent link. Thus noise and interference are cleaned up and clean signals are passed to the next leg of transmission, e.g. forwarded to the next relay node, to a UE or to a network node. In some of these embodiments, the first relay node 111 and/or the second relay node 112 is an IAB node. In other words, an IAB node is a type of regenerative relay node.

In some embodiments, the first relay node 111 and/or the second relay node 112 is a non-regenerative type of relay node. A non-regenerative type of relay node may be a relay node where a signal received by the relay node is simply amplified and forwarded to the subsequent link. No decoding-encoding is performed to clean up noise and interference for the next leg of transmission. In some of these embodiments, the first relay node 111 and/or the second relay node 112 is a repeater. In some embodiments, at least one of the first relay node 111 and the second relay node 112 is a stationary relay node. In other words, the first relay node and/or the second relay node has a fixed location. For example, the first relay node 111 and/or the second relay node 112 may be mounted on a light pole by roadside, or mounted on the wall of a building. In some embodiments, at least one of the first relay node 111 and the second relay node 112 is a mobile relay node. In certain scenarios, a mobile relay is desirable. In these scenarios, the first relay node 111 and/or second relay node 112 may be mounted in a mobile location, e.g. mounted on a vehicle such as a train, bus, or car, e.g. to provide communications for passengers. In some embodiments, a mobile relay set up to provide communications for first responders in an emergency scenario or disaster area.

The above embodiments will now be further explained and exemplified below. The embodiments below may be combined with any suitable embodiment above.

For the purpose of locating the first relay node 111, the first relay node 111 may be treated as a UE, e.g. wherein same methods for locating a UE are deployed. This is illustrated in an example scenario of FIG. 3, wherein the first location of the first relay node 111 is determined by orchestrating a signaling between the first relay node 111 and three network nodes in its neighborhood, e.g. the first set of network nodes. Various positioning methods may be used to locate the first relay node 111 with desired accuracy, e.g., using standard positioning techniques such as OTDOA, or UTDOA.

When the first location of the first relay node 111 has been determined, the first location server 101 may treat the first relay node 111 as a network node, e.g. in terms of localization methods, and use the first relay node 111 to locate other relay nodes in its vicinity, e.g. the second relay node 112 or the third relay node 113, or to locate UEs served by, or wirelessly connected to, the first relay node 111. For example, after the first relay node 111 is located, the first location may be communicated to a network node, e.g. a location server, such as the first location server 101 and/or the second location server 102. The first location may then be used with two other network nodes, e.g. the second set of network nodes, to be used for locating any one or more out of: the second relay node 112, the third relay node 113, and/or any UE served by, or wirelessly connected to, the first relay node 111.

In scenarios where the first, second and third relay nodes 111, 112, 113 are all located, e.g. the first, second, and third positions have been determined, the first, second, and third positions may be used to locate UEs served by, or wirelessly connected to any of the first, second or third relay nodes 111, 112, 113, without the use of any other network nodes. This provides higher precision since the relay nodes 111, 112, 113 are located closer to their UEs.

Also the network nodes of the first and/or second set of network nodes, e.g. gNBs, may use lower carrier frequency and Subcarrier Spacing (SCS), e.g., below-6 GHz with 15 kHz SCS, for coverage purpose. This does not provide high positioning accuracy for UEs 121, 122, 123. However, the relay nodes 111, 112, 113 may use a higher carrier frequency and SCS, e.g., above-6 GHz, with 120 kHz SCS, which thus achieves better positioning accuracy for the UEs 121, 122, 123.

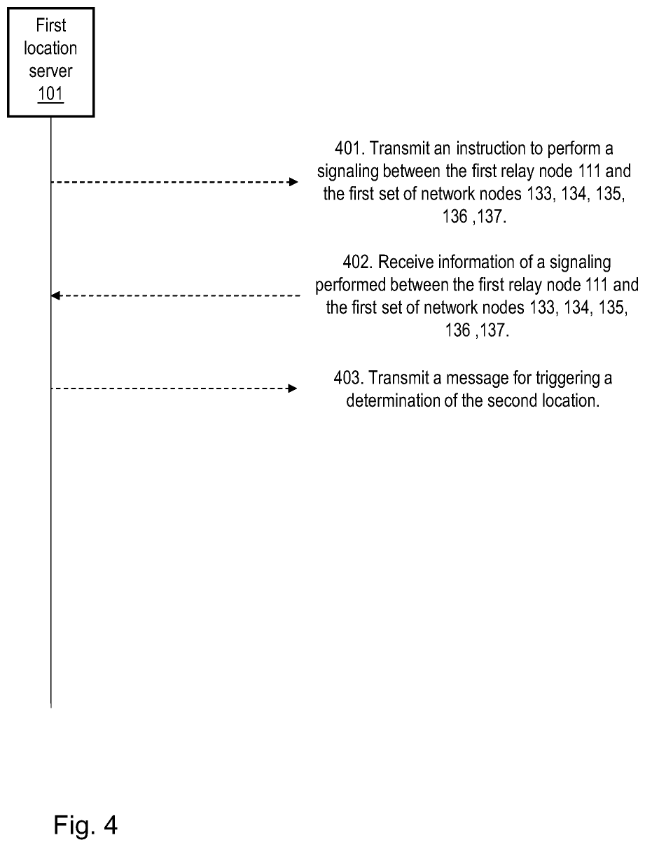

An example scenario is illustrated in FIG. 4 which summarize the communication for the first location server 101. Below actions may be optional and may be taken in any suitable order.

Action 401. The first location server 101 may transmit an instruction to perform the signaling between the first relay node 111 and the first set of network nodes 133, 134, 135, 136, 137. This may e.g. be sent to the first relay node 111 and/or to any one or more of the network nodes in the first set of network nodes. The first location server 101 may further trigger the signaling between the first relay node 111 and the first set of network nodes 133, 134, 135, 136, 137 in any suitable way, i.e., using a suitable positioning method, e.g. as described in action 201.

Action 402. In some embodiments, the first location server 101 may receive or obtain information of a signaling performed between the first relay node 111 and the first set of network nodes 133, 134, 135, 136, 137. This may be performed by receiving the information from between the first relay node 111 and/or the first set of network nodes.

Action 403. The first location server 101 may transmit an instruction to trigger a determination of the second location. This may be performed e.g. as described with reference to action 202b.

When determining or triggering the determination of any location e.g. the second and/or third location, the positioning method may be used in a device-assisted mode, e.g. wherein the first location server 101 may trigger a network device such as e.g. the second network device 121, 112 to perform measurements of its received radio signal from the first or second set of network nodes, and then to send the measurement data to the first or second location server 101, 102 to assist with a determination of its location the second location. In some embodiments, the positioning method is used in a network-assisted mode, e.g. the first location server 101 may trigger the first or second set of network nodes 133, 134, 135, 136, 137 to perform measurements of radio signal e.g. from the second network device 121, 112, and to send the measurement data to the first and/or second location server 101, 102 for determination of the second location. In some embodiments the positioning method is used in a device-based mode, e.g. the first location server 101 may trigger the second network device 121, 112 to determine its own location, e.g. the second location, and potentially share, e.g. transmit, its location to the first and/or second location server 101, 102. If the positioning method is used in a location-server-based mode, the first location server 101 may trigger the second network device 121, 112 and/or the first and/or second set of network nodes 133, 134, 135, 136, 137 to perform measurements of a radio signal, and to send the measurement results to the first and/or second location server 101, 102, such that the first and/or second location server 101, 102, for determination of the second location based on the measurements.

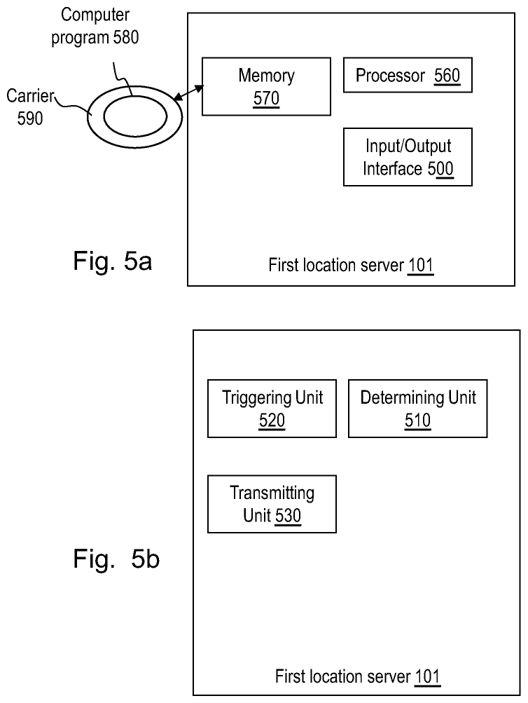

To perform the method actions above, the first location server 101 is configured to handle location data in the wireless communications network 100. The first location server 101 may comprise an arrangement depicted in FIGS. 5a and 5b.

The first location server 101 may comprise an input and output interface 500 configured to communicate with e.g. any one or more out of the second location server 102, the first, second, and/or third relay node 111, 112, 113, and the network nodes of the first and/or second set of network nodes 133, 134, 135, 136, 137. The input and output interface 500 may comprise a wireless receiver (not shown) and a wireless transmitter (not shown).

The first location server 101 may further be configured to, e.g. by means of a determining unit 510 in the first location server 101, determine a first location of a first relay node 111, wherein the first location of the first relay node 111 is based on a signaling performed between the first relay node 111 and a first set of network nodes 133, 134, 135, 136, 137.

The first location server 101 may further be configured to, e.g. by means of the determining unit 510 in the first location server 101, determine the first location is based on any one or more out of: one or more network node identifiers, one or more CIDs, at least one AoA value, at least one AoD value, at least one TA value, at least one signal quality value, pattern matching, at least one time difference value, and a barometric pressure value.

The first location server 101 may further be configured to, e.g. by means of a triggering unit 520 in the first location server 101, trigger a determination of a second location of a second network device 121, 112, wherein the second network device is any of: a first User Equipment, UE, 121 wirelessly connected with the first relay node 111, or a second relay node 112, and wherein the second location is triggered to be determined based on the first location.

The first location server 101 may further be configured to, e.g. by means of a triggering unit 520 in the first location server 101, trigger the determination of the second location of the second network device 121, 112 to be determined based on the first location and any one or more out of:
a signaling between the second network device 121, 112 and a second set of network nodes 133, 134, 135, 136, 137, and
a signaling between the second network device 121, 112 and the first relay node 111.

The first location server 101 may further be configured to, e.g. by means of a triggering unit 520 in the first location server 101, trigger the determination of the second location by any one out of:
determining e.g. by means of the determining unit 510 in the first location server 101, the second location of the second network device 121, 112 based on the first location, and
transmitting e.g. by means of a transmitting unit 530 in the first location server 101, a triggering message to any of the second network device 112, 121, the second location server 102, a network node in a first set of network nodes, or a network node in a second set of network nodes. The triggering message may in these embodiments trigger the determination of the second location of the second network device based on the first location.

In some embodiments, the second network device is the second relay node 112. In these embodiments, the first location server 101 may be configured to, e.g. by means of a triggering unit 520 in the first location server 101, trigger a determination of a third location of a third network device 122, 113, wherein the third network device 122, 113 is any of:
a third relay node 113, or
a second UE 122 wirelessly connected with the second relay node 112.

In some embodiments, the first relay node 111 and/or the second relay node 112 is a regenerative type of relay node. In some of these embodiments, the first relay node 111 and/or the second relay node 112 is an Integrated Access and Backhaul, IAB, node. In some embodiments, the first relay node 111 and/or the second relay node 112 is a non-regenerative type of relay node. In some of these embodiments, the first relay node 111 and/or the second relay node 112 is a repeater. In some embodiments, at least one of the first relay node 111 and the second relay node 112 is a stationary relay node, e.g. a stationary network node. In some embodiments, at least one of the first relay node 111 and the second relay node 112 is a mobile relay node, e.g. a mobile network node.

The embodiments herein may be implemented through a respective processor or one or more processors, such as the processor 560 of a processing circuitry in the first location server 101 depicted in FIG. 5a, together with respective computer program code for performing the functions and actions of the embodiments herein. The program code mentioned above may also be provided as a computer program product, for instance in the form of a data carrier carrying computer program code for performing the embodiments herein when being loaded into the first location server 101. One such carrier may be in the form of a CD ROM disc. It is however feasible with other data carriers such as a memory stick. The computer program code may furthermore be provided as pure program code on a server and downloaded to the first location server 101.

The first location server 101 may further comprise a memory 570 comprising one or more memory units. The memory 570 comprises instructions executable by the processor in first location server 101. The memory 570 is arranged to be used to store e.g. information, locations, data, configurations, and applications to perform the methods herein when being executed in the first location server 101.

In some embodiments, a computer program 580 comprises instructions, which when executed by the respective at least one processor 960, cause the at least one processor of the first location server 101 to perform the actions above.

In some embodiments, a respective carrier 590 comprises the respective computer program 980, wherein the carrier 990 is one of an electronic signal, an optical signal, an electromagnetic signal, a magnetic signal, an electric signal, a radio signal, a microwave signal, or a computer-readable storage medium.

Those skilled in the art will appreciate that the units in the first location server 101 described above may refer to a combination of analog and digital circuits, and/or one or more processors configured with software and/or firmware, e.g. stored in the first location server 101, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

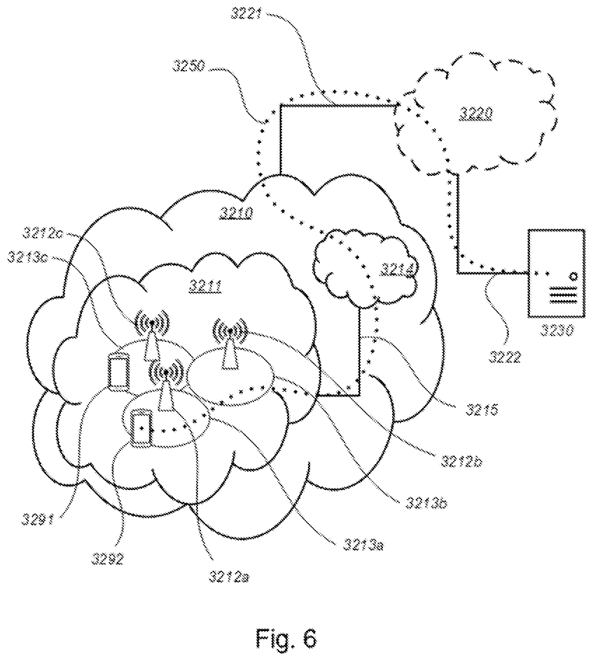

With reference to FIG. 6, in accordance with an embodiment, a communication system includes a telecommunications network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as any of the network nodes in the first and/or second set of network nodes, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the first UE 121 such as a Non-AP STA 3291 located in coverage area 3213c is configured to wirelessly connect to, or be paged by, the corresponding base station 3212c. A second UE 3292 e.g. the second UE 122, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunications network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunications network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

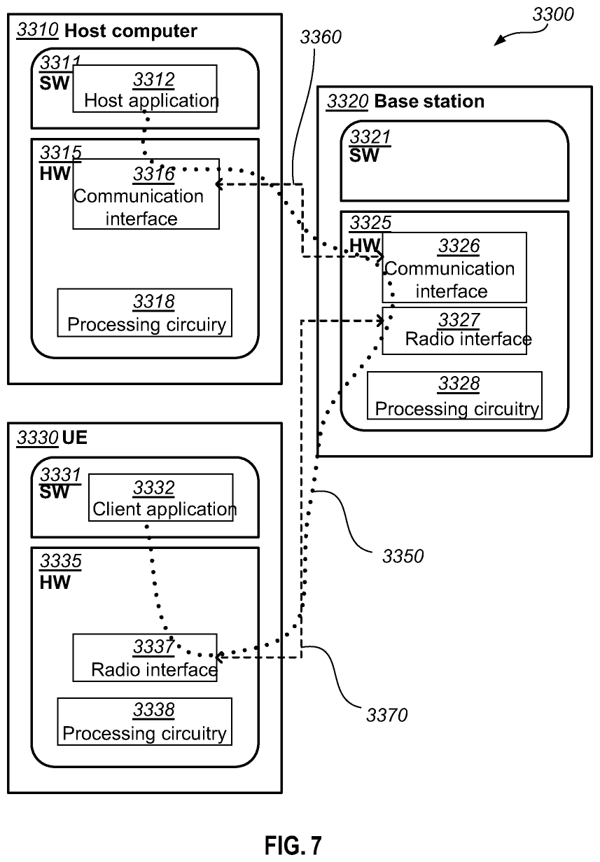

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 7 may be identical to the host computer 3230, one of the base stations 3212a, 3212b, 3212c and one of the UEs 3291, 3292 of FIG. 6, respectively. This is to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure.

One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, reduced interference, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

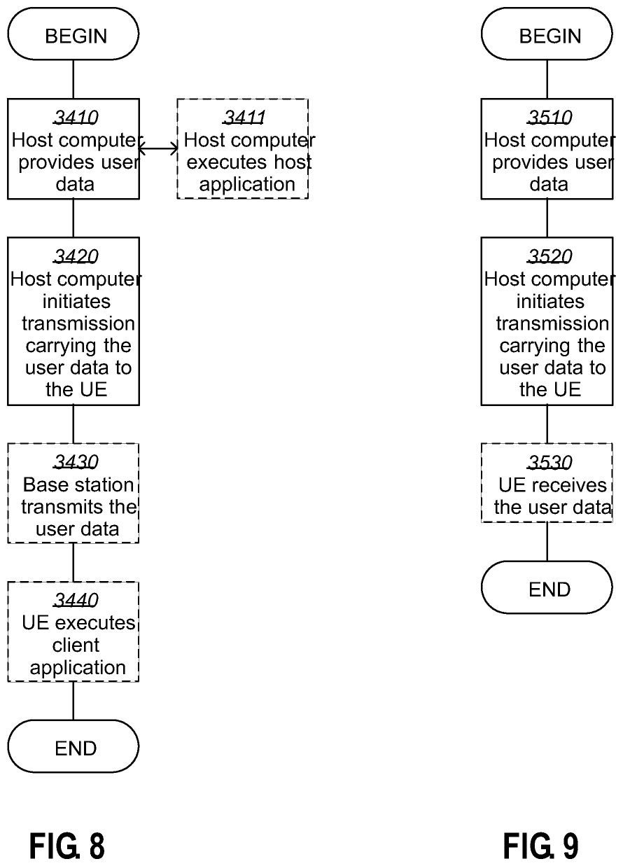

FIG. 8 is a flowchart illustrating a method implemented in a communication system, in accordance with one embodiment. The communication system includes a host computer, a base station such as e.g. any of the network nodes in the first and/or second set of network nodes, and a UE such as e.g. the first UE 121 or the second UE 122, which may be those described with reference to FIG. 6 and FIG. 7. For simplicity of the present disclosure, only drawing references to FIG. 8 will be included in this section. In a first action 3410 of the method, the host computer provides user data. In an optional sub action 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 9 will be included in this section. In a first action 3510 of the method, the host computer provides user data. In an optional sub action (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

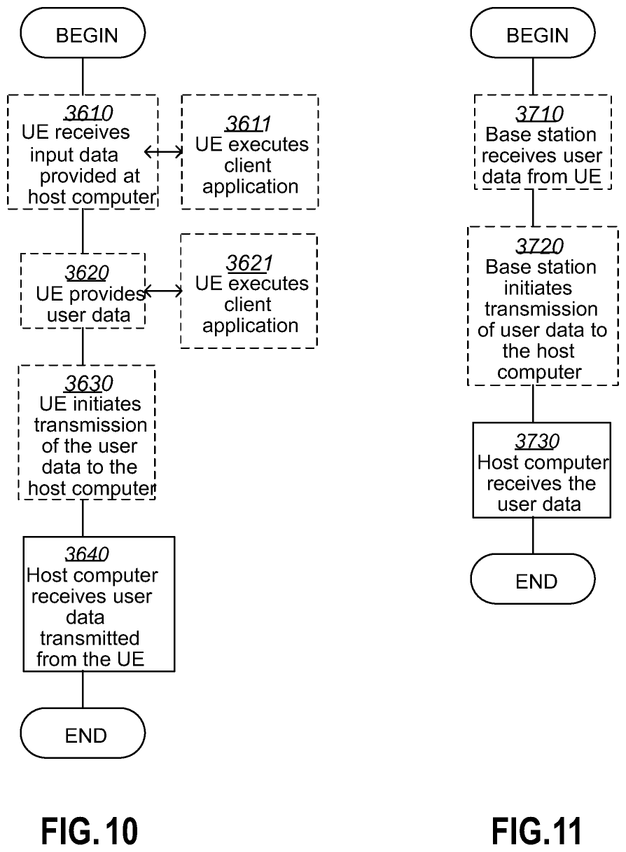

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 10 will be included in this section. In an optional first action 3610 of the method, the UE receives input data provided by the host computer. Additionally or alternatively, in an optional second action 3620, the UE provides user data. In an optional sub action 3621 of the second action 3620, the UE provides the user data by executing a client application. In a further optional sub action 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub action 3630, transmission of the user data to the host computer. In a fourth action 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7 For simplicity of the present disclosure, only drawing references to FIG. 11 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a first location server for handling location data in a wireless communications network, the method comprising:
determining a first location of a first relay node, the first location of the first relay node being based on a signaling performed between the first relay node and a first set of network nodes; and
triggering a determination of a second location of a second network device, the second network device being any of: a first User Equipment, UE, wirelessly connected with the first relay node, or a second relay node, and the second location being triggered to be determined based on the first location.

2. The method according to claim 1, wherein the determination of the second location of the second network device is triggered to be determined based on the first location and any one or more out of:
a signaling between the second network device and a second set of network nodes; and
a signaling between the second network device and the first relay node.

3. The method according to claim 1, wherein determining the first location is based on any one or more out of: an identifier of a network node in the first set of network nodes, one or more cell identifiers, CIDs, at least one Angle of Arrival, AoA, value, at least one Angle of Departure, AoD, value, at least one Timing Advance, TA, value, at least one signal quality value, pattern matching, at least one time difference value, and a barometric pressure value.

4. The method according to claim 1, wherein triggering the determination of the second location comprises any one out of:
determining the second location of the second network device based on the first location; and
transmitting a triggering message to any of the second network device, a second location server, a network node in the first set of network nodes, or a network node in the second set of network nodes, wherein the triggering message triggers the determination of the second location of the second network device based on the first location.

5. The method according to claim 1, wherein the second network device is the second relay node, and wherein the method further comprises triggering a determination of a third location of a third network device, wherein the third network device is any of:
a third relay node; or
a second UE wirelessly connected with the second relay node.

6. The method according to claim 1, wherein the one or both of first relay node and the second relay node is any of an Integrated Access and Backhaul, IAB, node or a repeater.

7. The method according to claim 1, wherein at least one of the first relay node and the second relay node is a mobile relay node.

8. A first location server configured to handle location data in a wireless communications network, the first location server is configured to:
determine a first location of a first relay node, the first location of the first relay node being based on a signaling performed between the first relay node and a first set of network nodes; and
trigger a determination of a second location of a second network device, wherein the second network device is any of: a first User Equipment, UE, wirelessly connected with the first relay node, or a second relay node, and the second location being triggered to be determined based on the first location.

9. The first location server according to claim 8, wherein the determination of the second location of the second network device is triggered to be determined based on the first location and any one or more out of:
a signaling between the second network device and a second set of network nodes; and
a signaling between the second network device and the first relay node.

10. The first location server according to claim 8, further configured to determine the first location is based on any one or more out of: one or more network node identifiers, one or more cell identifiers, CIDs, at least one Angle of Arrival, AoA, value, at least one Angle of Departure, AoD, value, at least one Timing Advance, TA, value, at least one signal quality value, pattern matching, at least one time difference value, and a barometric pressure value.

11. The first location server according to claim 8, further configured to trigger the determination of the second location by any one out of:
determining the second location of the second network device based on the first location; and
transmitting a triggering message to any of the second network device, a second location server, a network node in the first set of network nodes, or a network node in the second set of network nodes, wherein the triggering message triggers the determination of the second location of the second network device based on the first location.

12. The first location server according to claim 8, wherein the second network device is the second relay node, and wherein the first location server is configured to trigger a determination of a third location of a third network device, wherein the third network device is any of:
a third relay node; or
a second UE wirelessly connected with the second relay node.

13. The first location server according to claim 8, wherein one or both of the first relay node and the second relay node is any of an Integrated Access and Backhaul, IAB, node or a repeater.

14. The first location server according to claim 8, wherein at least one of the first relay node and the second relay node is a mobile relay node.

15. A computer storage medium storing a computer program comprising instructions, which when executed by a processor, causes the processor to:
determine a first location of a first relay node, the first location of the first relay node being based on a signaling performed between the first relay node and a first set of network nodes; and
trigger a determination of a second location of a second network device, the second network device being any of: a first User Equipment, UE, wirelessly connected with the first relay node, or a second relay node, and the second location being triggered to be determined based on the first location.

16. (canceled)

17. The method according to claim 2, wherein determining the first location is based on any one or more out of: an identifier of a network node in the first set of network nodes, one or more cell identifiers, CIDs, at least one Angle of Arrival, AoA, value, at least one Angle of Departure, AoD, value, at least one Timing Advance, TA, value, at least one signal quality value, pattern matching, at least one time difference value, and a barometric pressure value.

18. The method according to claim 2, wherein triggering the determination of the second location comprises any one out of:
determining the second location of the second network device based on the first location; and
transmitting a triggering message to any of the second network device, a second location server, a network node in the first set of network nodes, or a network node in the second set of network nodes, wherein the triggering message triggers the determination of the second location of the second network device based on the first location.

19. The method according to claim 2, wherein the second network device is the second relay node, and wherein the method further comprises triggering a determination of a third location of a third network device, wherein the third network device is any of:
a third relay node; or
a second UE wirelessly connected with the second relay node.

20. The method according to claim 2, wherein the one or both of the first relay node and the second relay node is any of an Integrated Access and Backhaul, IAB, node or a repeater.

21. The method according to claim 2, wherein at least one of the first relay node and the second relay node is a mobile relay node.
